(19) United States
(12) Patent Application Publication
(10) Pub. No.: US 2010/0146814 A1
(43) Pub. Date: Jun. 17, 2010

(54) Vibratory Flash Dryer

(76) Inventors: Stephen T. Baker, Louisville, KY (US); David Hubbs, Louisville, KY (US)

Correspondence Address: MIDDLETON & REUTLINGER, 2500 BROWN & WILLIAMSON TOWER, LOUISVILLE, KY, 40202, US

(21) Appl. No.: 12/332,745

(22) Filed: Dec. 11, 2008

(51) Int. Cl. F26B 17/00; F26B 19/00

(52) U.S. Cl. 34/580; 34/586; 34/549

(57) ABSTRACT

An apparatus for drying and conveying a material includes a vibratory fluid bed dryer having a perforated drying deck on which material is deposited, said fluid bed dryer including a vibratory drive system capable of imparting a variable angle vibratory force to the deck. A flash dryer is also provided, having a fan and heater for supplying hot air through the fluid bed dryer deck and a cyclone for collecting finished, dried material particles.

### BACKGROUND OF THE INVENTION

1. Field of the Invention

The present invention relates generally to a system for transporting and drying a moisture laden bulk material and more particularly to a vibratory flash drying system having a fluid bed dryer for effecting rapid heat transfer to moisture laden bulk material operating in conjunction with a flash dryer wherein dried material particles are entrained in an airstream to exit the fluid bed dryer and enter the flash dryer for final processing. Oversized particles are too heavy to be conveyed in the exhaust air stream and thus remain on the fluid bed dryer deck to be either broken up with vibratory motion or discharged from a discharge end of the fluid bed dryer.

2. Description of the Related Art

Various types of systems for heating and drying various filter cakes and like products that are typically processed into fine powders are known in the art. Many manufacturing industries produce particles, powders, or granules of various materials such as fertilizer granules, soap powders, drink mix powders, food powders, minerals and the like that must be dried, handled and processed in bulk, most often as part of a continuous production process. Many of these products must be heated, dried, and processed into a fine powder or particulate prior to the next step in the production process or packaging. Accordingly, various devices for drying fine particulates exist in the art.

For example, some prior art systems utilize belt dryers that provide a steady flow of hot air to a perforated belt to dry wet particulates in conjunction with a conventional mill to reduce their particle size. Many of these particulates are introduced into the processing stream as “lumps” of filter cakes which must be dried and reduced in size to be used further. Typically, belt dryer systems are used in conjunction with a mill, such as a cage mill, to reduce the particle size either subsequent to, or prior to drying, or both. These systems are not optimal for producing consistent fine particulates for several reasons. Firstly, the cage mills are subject to clogging when wet materials are introduced, and thus require several mills for a single process. Secondly, belt dryers require large material residence time to produce even drying of the material, and thus typically require a large factory footprint.

Additionally, some prior art solutions utilize fluid beds, either vibratory or conventional, for drying wet powders and granular substances. Fluid bed equipment operates by forcing a hot gas through a distribution plate or belt that holds a layer or “bed” of wet material. The hot gas passes from an inlet, or a plurality thereof, through the distribution plate to dry the wet material at such a velocity as to permit the material to flow readily about the distribution plate. Energy transfer from gas to material is efficient because many material particles are completely surrounded by hot gas. Hot and cold spots are minimized as well. The velocity of gas provided through the fluid bed dryer, called the fluidizing velocity, must be carefully controlled to avoid entraining a substantial portion of the particulates in the exhaust airstream. Typically, as much as ten percent of the material in the fluid bed will eventually exit the bed via an exhaust gas stream and must then be reclaimed through various filtration systems. Obviously, materials having large mean particle sizes and higher densities can use higher fluidizing velocities, while those having smaller particles must use lower fluid velocities

Materials having relatively narrow particle size distributions are readily processed by conventional fluid bed dryers. Where particle size distribution is widely variable between large and small particles, vibratory fluid beds may be employed to move the larger particles to a discharge end of the conveying bed so that they may be reprocessed. This allows the fluidizing velocity to be optimized for a target mean particle size.

Fluid beds, either conventional or vibrating, are not optimal for use where the wet material particle sizes are quite small, for example particles sizes less than 50 μm, unless material density is very high. In such applications, flash dryers are employed to rapidly dry the particulates, entrain them in an airstream, and capture them in a bag house or similar filtration system. However, flash dryers do not work particularly well for particulates that are very wet, or enter the process in the form of filter cakes. These particulates must usually be processed by a mill or screen of some variety, prior to entry into the flash dryer, which adds complexity and expense to the system. Furthermore, flash dryers often require the material to be introduced into the system multiple times until the particles are dry enough to be entrained into the airstream.

Accordingly, it is readily seen that materials having high moisture content or widely varying particle sizes are difficult to dry and process utilizing existing drying systems.

### SUMMARY OF THE INVENTION

The present invention obviates the aforementioned problems inherent in the prior art by providing a vibratory flash drying system for drying and collecting materials that enter the system in the form of wet cakes or lumps and exit the system as fine particulates. In particular, the system of the present invention employs a fluid bed dryer having a vibratory drive secured thereto that imparts a variable angle vibratory motion to a vibratory deck housed in the dryer. The vibratory distribution plate includes a plurality of perforations or apertures therein that permit a hot, high velocity air stream to flow upwardly through the deck, thus drying material that is deposited thereon.

The invention further includes a flash dryer for supplying a hot gas or air stream to the fluid bed dryer at a velocity sufficient to fluidize the material on the deck, thereby exposing the maximum amount of material to drying air. The flash dryer may include a fan, a damper for controlling air stream velocity, and an air heater for controlling air stream temperature. Furthermore, a plurality of temperature sensors may be provided at various points in the system to monitor the air stream temperature to assure proper and thorough drying of material particles.

The flash dryer system may also include a filtration system having a hopper for storing finished product, and an exhaust fan and concomitant dust filter for withdrawing the exhaust air stream from the fluid bed dryer. Additionally, a controller is provided to control the fluid bed dryer and flash dryer of the present invention, whereby a hot air stream temperature, fluid bed dryer deck vibration angle, and air velocity may be employed as control variables and thus controlled through electrical outputs to system components.

Other features, objects and advantages of the present invention will become apparent from the detailed description of the preferred embodiments appended herein below and taken in conjunction with the attached drawing Figures.

### BRIEF DESCRIPTION OF THE DRAWING FIGURES

FIG. 1 is an elevation view of a fluid bed dryer in accordance with one embodiment of the present invention.

FIG. 2 is a cross-sectional view of a fluid bed dryer taken along the line 2-2 of FIG. 1 in accordance with one embodiment of the present invention.

FIG. 3 is an elevation view of a fluid bed dryer in accordance with one embodiment of the present invention.

FIG. 4a is a block diagram schematic of a vibratory flash dryer system in accordance with one embodiment of the present invention.

FIG. 4b is a block diagram schematic of a vibratory flash dryer system in accordance with one embodiment of the present invention.

FIG. 4c is a block diagram schematic of a vibratory flash dryer system in accordance with one embodiment of the present invention.

### DETAILED DESCRIPTION OF THE PREFERRED EMBODIMENT(S)

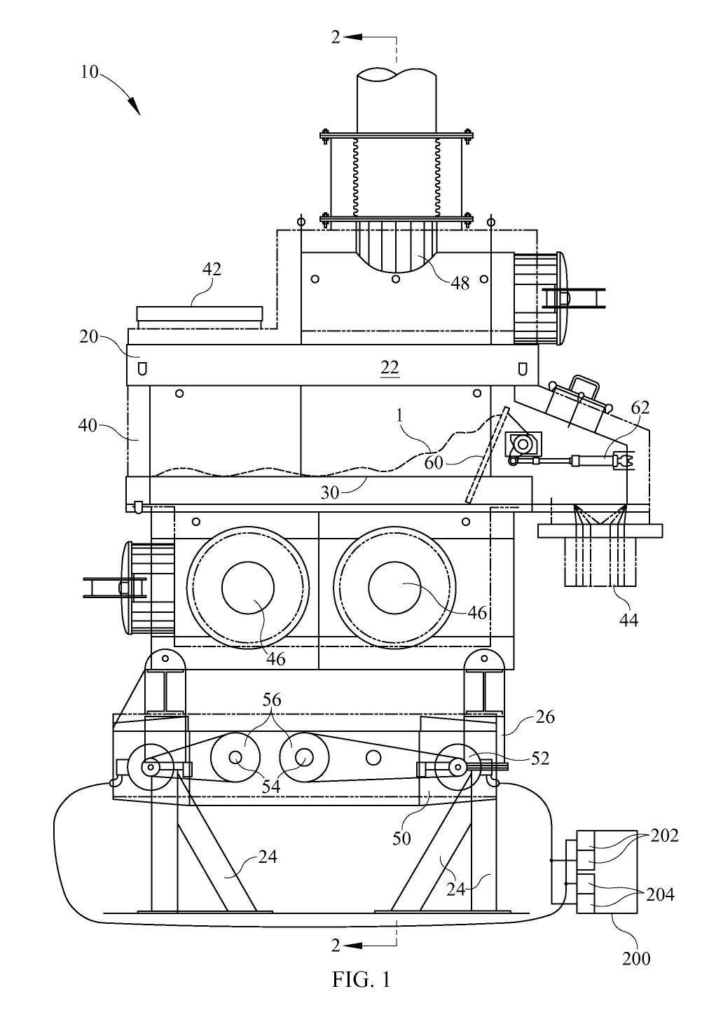

Referring now to the drawing Figures, and in accordance with a one embodiment of the present invention a vibratory flash dryer system 10 capable of effecting heat transfer to or from a moisture-laden bulk material 1 includes a fluid bed dryer 20 in fluid communication with a flash dryer system 100, each supplied with a hot gas (for example air) by a gas heater system 120. As best seen in FIGS. 1-3, fluid bed dryer 20 comprises an exterior housing 40 mounted to a vibratory frame 24 having spring members 26 for isolating vibration from fluid bed dryer 20. Spring member 26 may be rubber marshmallow type spring or coil springs.

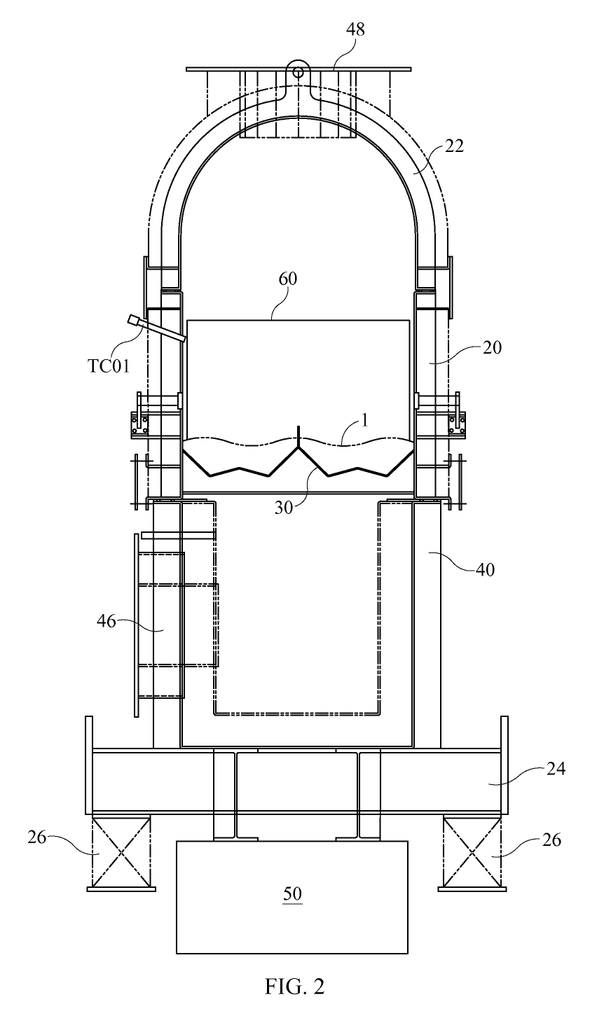

Fluid bed dryer 20 further includes a distribution plate 30 running longitudinally substantially the length of the housing on which wet or moisture-laden material 1 is deposited, the distribution plate 30 having a plurality of perforations or apertures therein through which hot or cool gas may flow. As shown in the drawing Figures, air flow direction is indicated by solid lines with arrows pointing the direction of the flow stream. In one embodiment of the invention as best seen in FIG. 2, a distribution plate 30 having a “W” shaped or corrugated cross-section is provided which enables greater mixing of hot gas with material 1 as the hot gas flowing through plate 30 is directed in a plurality of directions as it passes through plate 30. This enhanced mixing action permits the use of lower fluidizing velocities, and thus less energy consumption, while providing superior fluidizing and drying of material 1. Fluid bed dryer 20 may also comprise a pressure transducer PT01, disposed at a point inside dryer 20 above distribution plate 30 (for example in the exhaust hood) for sensing pressure above plate 30.

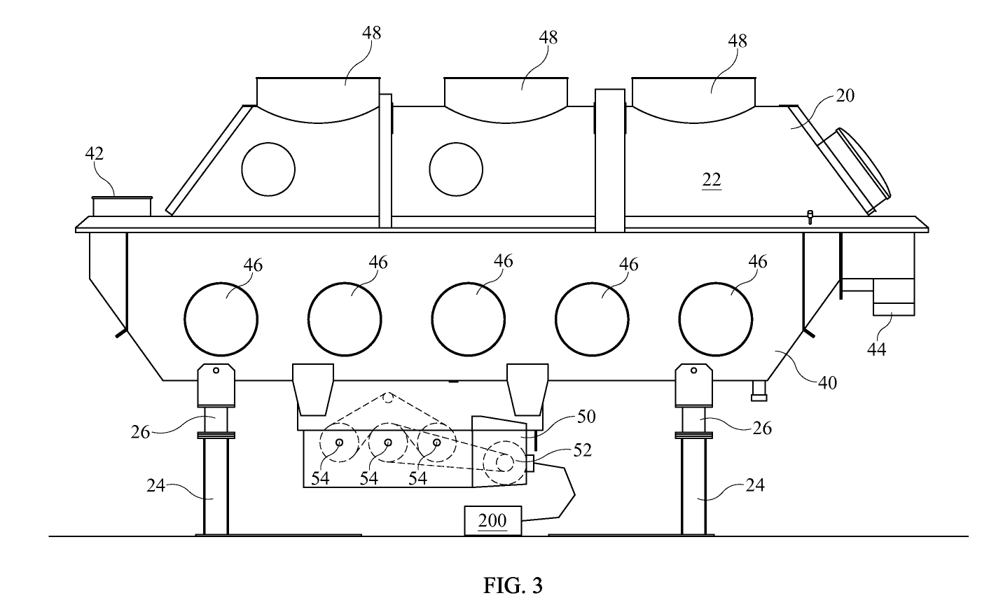

Housing 40 further comprises a material inlet port 42, through which material 1 is deposited on distribution plate 30, as well as a rejected product outlet port 44, through which oversized material particles, termed “overs”, exit fluid bed dryer 20. Housing 40 further includes a plurality of air inlet ports 46, located below a bottom surface of distribution plate 30 for supplying hot gas to fluid bed dryer 20, and an exhaust hood 22, having an exhaust port 48, or a plurality thereof as shown in FIG. 3, through which dried material 1 exits, entrained in an exhaust gas stream as will be discussed in greater detail herein below. FIG. 3 depicts an alternative fluid bed dryer 20 having a plurality of air inlet ports 46 as well as a plurality of exhaust ports 48, wherein distribution plate 30 is disposed above air inlet ports 46.

Referring again to FIGS. 1-3 fluid bed dryer 20 further comprises a vibratory fluid bed drive 50, for example a differential motion drive as disclosed and claimed in U.S. Pat. No. 5,615,763 to Schieber, incorporated herein by reference. Vibratory drive 50 may comprise a motor or motors 52 driving a plurality of shafts 54, each having eccentric weights secured thereto such that a vibratory force is imparted to fluid bed dryer depending upon the relative position of shafts 54 and eccentric weights 56 to each other. Drive 50 may be electrically coupled to a controller 200 having a plurality of inputs 202 and outputs 204 electrically coupled to various components of drive 50 as well as system 10, wherein controller 200 is capable of controlling motor 52 speed by means of a speed control output(s) 204 to a variable frequency drive or drives (not shown). The speed of motors 52 thus determines the position of shafts 54 relative to one another, and thereby determines the angle of vibratory force imparted to deck 30. A plurality of shaft position sensors (not shown) may be provided as inputs 202 to controller 200, thereby enabling controller 200 to determine the relative position of shafts 54 and thus the eccentric weights secured thereto. Controller 200 calculates a real phase angle signal corresponding to the phase angle difference between shafts 54 by determining the position of the shaft sensors relative to one another, and then provides outputs 204 to the variable frequency drives to adjust the speed of motors 50 until the real phase angle approximately matches a predetermined phase angle, which is representative of the desired direction of magnitude of vibratory force imparted to dryer 20. Additionally, controller 200 may include a microprocessor for executing software instructions as well as a concomitant data memory as is well known to one of ordinary skill in the art. Typical controllers suitable for use in conjunction with system 10 include, but are not limited to, programmable logic controllers (PLC's), distributed control systems, personal computers and other microprocessor based control systems, as well as associated operator interfaces. Furthermore, an operator interface (not shown) such as a keyboard or touch screen may be operatively coupled to controller 200 to enable an operator to controller the functioning of system 10 as well as enter temperature and pressure set points as discussed below.

Drive 50 imparts a variable angle component of force to fluid bed dryer 20 and thus distribution plate 30, which is supported by spring members 26, thereby providing a system to convey any material 1 disposed on deck 30 that is not entrained in fluidizing air across plate 30 from inlet port end 42 to outlet port 44. In one embodiment of the invention, vibratory drive 50 motors 52 are operated when material 1 is being fed into fluid bed dryer 20 to disperse material 1 across plate 30, or when oversized particles are being removed from deck plate through outlet port 44. Otherwise, motors 52 remain on while hot fluidizing air is provided across plate 30, as discussed in further detail herein below.

Alternatively, when certain materials 1 having high densities are being processed, it is advantageous to operate drive motors 52 to impart, for example, a vertical vibratory force to distribution plate 30 to assist in the breakup of material 1 particles. The heavier material 1 particles, which are to large to be fluidized, remain on plate 30 and are thus subjected to the application of vibratory force through plate 30. Accordingly, the instant invention provides a system 10 wherein material 1 may be processed utilizing vibratory force, flash drying, or both in variable amounts depending upon the physical characteristics and moisture content of the material being processed.

Referring again to FIG. 1, fluid bed dryer 20 may further comprise a weir 60 located proximate the outlet port 44 of dryer 20, which may be raised and lowered by means of an actuator 62, shown in FIG. 1 as an pneumatic cylinder. Actuator 62 may comprise an electrical actuator or hydraulic cylinder without departing from the scope of the invention. Actuator 62 may be operated by an output 204 from controller 200, for example by operating a servo-valve or solenoid valve. Alternatively, actuator 62 may comprise an electrically operated gate valve or equivalent mechanism that raises weir 60 into a position to block material 1 from flowing along distribution plate 30 into outlet port 44, and then lowered to permit passage of material 1 along distribution plate 30 through outlet port 44. In this embodiment of the invention, oversized material 1 particles that do not break down and dry sufficiently to be entrained in the exhaust gas stream of fluid bed dryer 20 may be released through port 44 at predetermined time intervals for further processing, discarding, or for reintroduction into inlet port 42. In one embodiment of the invention, when processing materials of high density and high moisture content, the length of time between releasing material 1 to outlet port 44 may be reduced by suitably programming controller 200 to activate an output 204 to energize actuator 62 at a relatively short cycle rate. Accordingly, materials 1 having lower densities and/or low moisture contents may require lesser weir 60 cycle rates, since more material 1 will be removed through the exhaust gas stream.

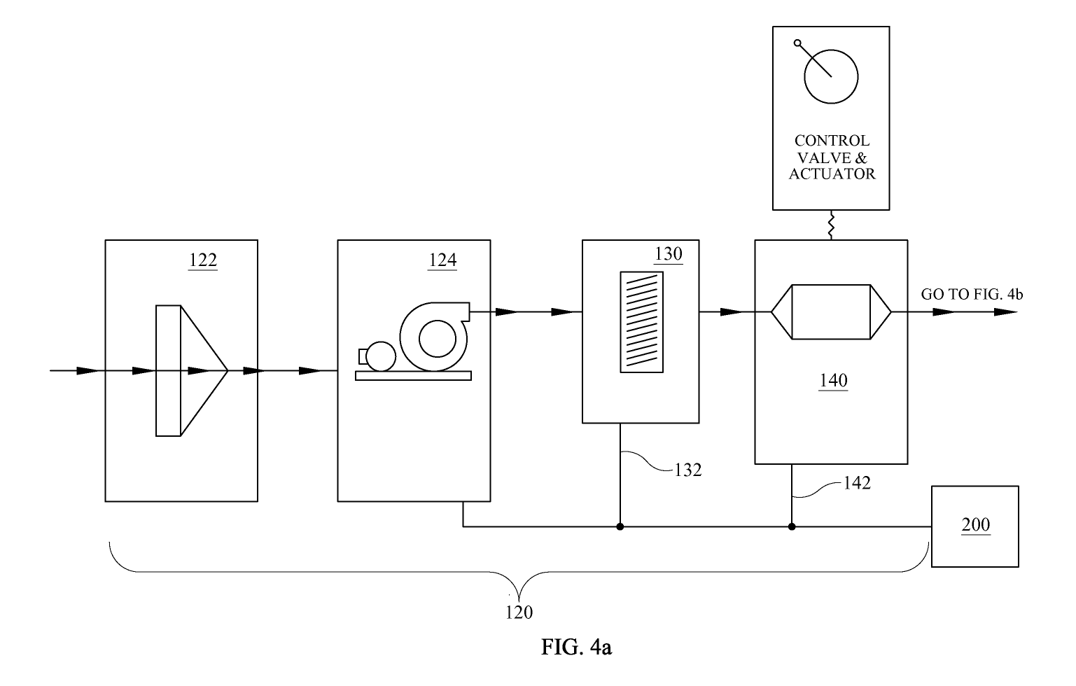

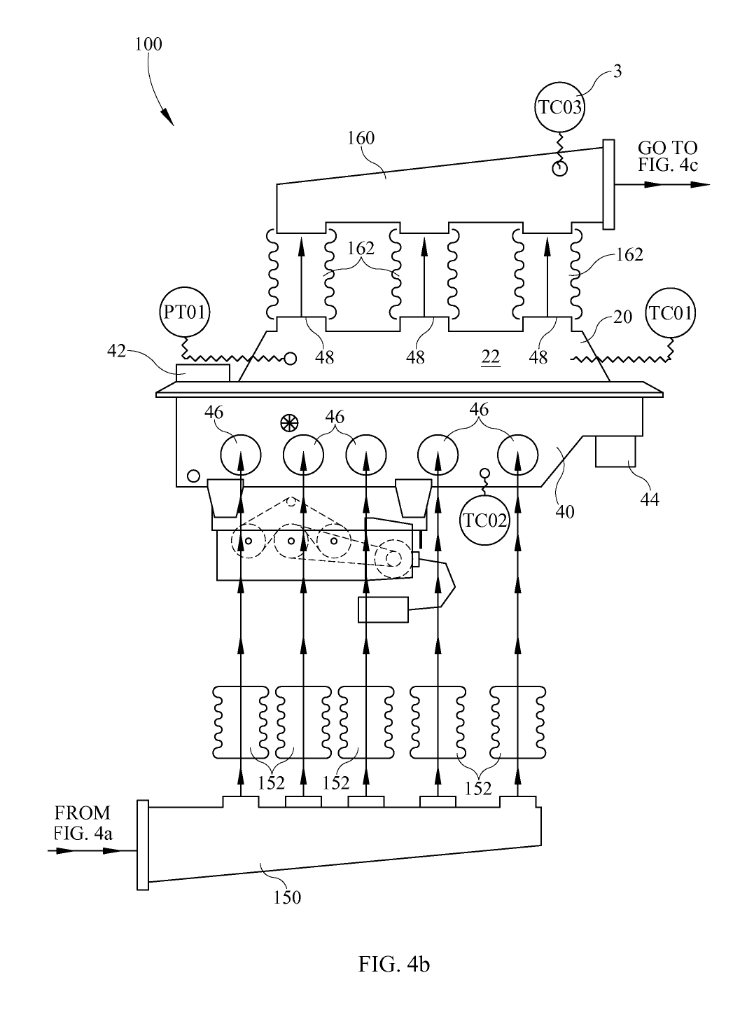

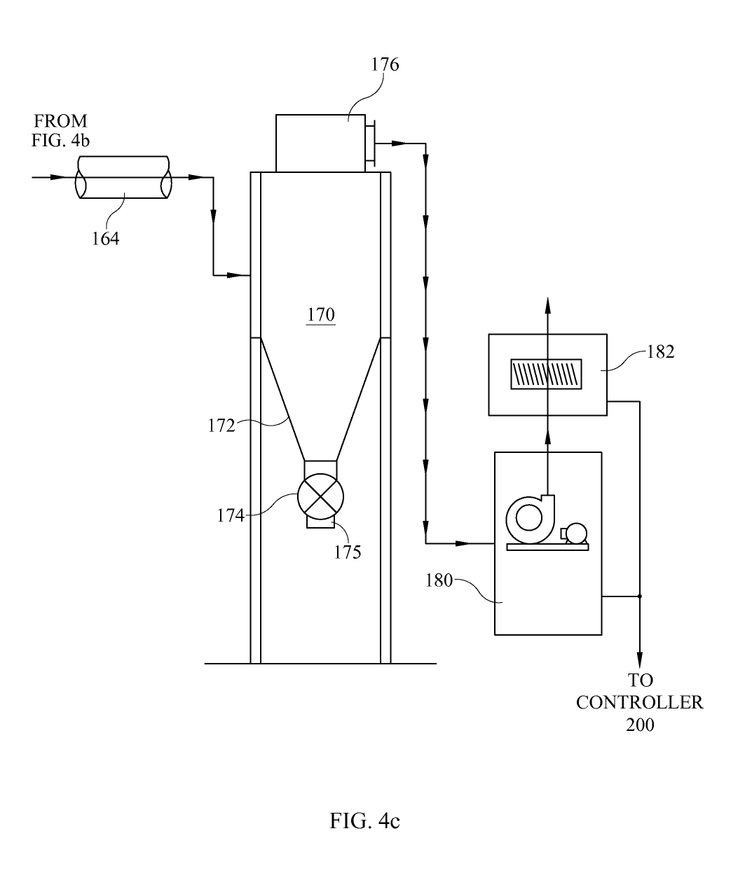

Referring now to FIGS. 4a-4c, and in accordance with one embodiment of the present invention, system 10 further comprises a flash dryer system 100 including an air supply system 120 which may include a supply air filter housing 122 for removing particulates and contaminants from supply air and a motor-operated fan 124 in fluid communication with filter housing 122 for accelerating the air supplied through filter housing 122. Fan 124 may be a variable speed fan capable of being controlled by a speed output 204 from controller 200. Alternatively, fan 124 may be a single speed fan that is merely activated by an output 204 from controller 200. Note that air flow through system 10 is indicated in the drawing figures by directional arrows.

Additionally, air supply system 120 may include a damper 130 in fluid communication with fan 124 which may be operated to control the velocity of filtered air entering a heater 140, that is used to heat the air flowing into fluid bed dryer 20 to a predetermined set point temperature, as will be discussed further herein below. Damper 130 may include a velocity input 132 that is electrically coupled to a velocity output 204 of controller 200 providing an electrical signal to damper 130 to indicate damper position, and thus air stream velocity into heater 140. Damper 130 may also be controlled responsive to a temperature sensor provided in the exhaust air stream of fluid bed dryer 20, as discussed further herein below.

Heater 140 may comprise a commercially available gas or electrical resistance heater capable of rapidly heating an entering air stream to a desired set point temperature. Heater 140 may include an input 142 that accepts a temperature set point output signal 204 from controller 200 that may be selected as desired for materials 1 having differing characteristics. Accordingly, the instant invention 10 permits both the gas velocity and temperature to be controlled utilizing damper 130 and heater 140 depending upon drying requirements of material 1.

As best seen in FIG. 4a, an inlet air header 150 is in fluid communication with air heater 140, and directs air through a plurality of flexible connectors 152 into fluid bed dryer 20 air inlet ports 46, whereby the hot air stream provides fluidizing air to distribution plate 30 and any material 1 deposited thereon. An exhaust header 160 is in fluid communication with exhaust ports 48 of fluid bed dryer 20 through a plurality of flexible connectors 162, thereby providing an exit route for dried material 1 entrained in the exhaust air stream which exits fluid bed dyer 20 through exhaust header 160.

Flash dryer system 100 further comprises a cyclone 170 that is in fluid communication with exhaust header 160 through conventional ductwork 164 or piping. Cyclone 170 comprises a housing 172 having a rotary valve 174 in communication with an outlet port 175 at a lower end thereof for removing finished material 1, and may further include a cyclone dust outlet 176 located at an upper end thereof for filtering and separating exhaust air from dried material 1 particulates.

Additionally, an flash dryer system 100 includes an exhaust fan 180 in fluid communication with outlet 176, the exhaust fan 180 being further equipped with a damper 182 for controlling air flow volume through outlet 176, and thus controlling air pressure within cyclone 170 to enable material 1 particles entrained in the exhaust air stream to drop downwardly into cyclone housing 172 while filtering and removing exhaust air from cyclone 170. In one embodiment of the invention exhaust fan 180 and damper 182 are capable of accepting an electrical output signal 204 from controller 200 whereby controller 200 may be suitably programmed to provide a predetermined pressure in exhaust hood 22, as measured by pressure transducer PT01 by controlling the operation of damper 182, thereby controlling air volume through the system.

Additionally, exhaust fan 180 and damper 182 are operated in concert with inlet air fan 124 and damper 130 to maintain a slight negative pressure across distribution plate 30 to enable material 1 particulates that have dried sufficiently to be entrained within the air stream and exit fluid bed dryer 20 through exhaust header 160. Pressure transducer PT01 is operatively coupled to an input 202 of controller 200, to provide a signal representative of pressure above distribution plate 30 to controller 200. The air flow through 10 system operates in a push/pull fashion, whereby inlet air fan 124 and damper 130 are controlled by controller 200 outputs 204 to push air into fluid bed dryer 20, while exhaust fan 180 and damper 182 are controlled by outputs 204 to withdraw air therefrom, as required by the pressure measured by PT01. This feature of the invention permits accurate control of pressure across distribution plate 30, which in turn provides that only properly dried material 1 is entrained within the air stream exiting flash dryer 20. Where larger material 1 particles are required, or where finished particle moisture content is higher, the pressure across distribution deck 30 can be reduced further to enable heavier, denser particles to exit flash dryer 20. As can be seen by the foregoing description, by providing a predetermined pressure setpoint to controller 200 via an operator interface, the particle size entrained in exhaust air may be modified to produce finished material 1 particles of a desired size.

In one embodiment of the present invention a plurality of temperature sensors TC01, TC02 and TC03 are provided in fluid bed dryer 20 to monitor the air temperature at various points in the flash drying process. Temperature sensors TC01, TC02 and TC03 may be any commercially available temperature sensor suitable for use at drying air temperatures such as thermocouples or resistive thermocouple devices. Each temperature sensor TC01, TC02 and TC03 provides an electrical output representative of temperature to an input 202 of controller 200, whereby controller 200 may monitor said temperature sensors and adjust heater 140 temperature set point by providing a suitable output 204 to heater 140 input 142. TC01 may be located, for example inside exhaust hood 22 of fluid bed dryer 20, above deck 30 to monitor the temperature proximate the fluidized air and material. Temperature sensor TC02 may be located inside housing 40 below deck 30 to monitor heated air coming from inlet header 150. Temperature sensor TC03 may be located inside exhaust air header 160 to monitor the temperature of air exiting fluid bed dryer 20, along with material 1 entrained in the air stream.

In operation, wet material 1 is introduced into inlet port 42 while vibratory drive 50 is set to provide a predetermined angle of vibratory force to fluid bed dryer 20 sufficient to advance material 1 along the length of deck 30. Air supply fan 124 and heater 140 are then turned on by controller 200 outputs 204, to provide hot air through inlet header 150 and across perforated deck 30. Depending upon the material 1 being processed, the angle of vibration of vibratory drive can be set to vertical, that is to say at right angles to deck 30, or set such that material 1 is slowly advanced towards weir 60. In an alternative embodiment of the present invention, where material 1 has a consistency and moisture content that does not require vibratory motion to break up large particles, vibratory drive 50 may be turned off.

Controller 200 may accept a temperature setpoint input from an operator interface, and in turn provides a temperature set point output 204 to heater 140 input 142 and a velocity output 204 to input 132 of damper 130 to regulate both the velocity of air crossing through deck 30 and the temperature thereof. Controller 200 monitors temperature sensors TC01, TC02 and TC03 to maintain a desired temperature set point.

In one embodiment of the present invention, temperature sensor TC03 is used as a process variable to control the temperature set point provided to heater 140. In this embodiment, for a given material it may be known that the temperature required in the exhaust gas stream to produce consistent finished material 1 is T1 degrees Fahrenheit, such that controller 200 increases the temperature set point of heater 140 until T1 degrees is attained as determined by TC03. In this simple feedback control loop example the temperature at TC03 determines the temperature output 204 to be provided to input 142 of heater 140.

Alternatively, temperature sensor TC01 is used as a process variable to control the temperature set point provided to heater 140. By maintaining the exhaust hood temperature, as measured by sensor TC01 at a predetermined set point as required to provide complete drying of material 1, controller 200 can ensure a relatively constant moisture content of finished material. Where the moisture content of material entering flash dryer 20 increases, the temperature measured at TC01 (or at temperature sensor TC03) will typically increase since additional heat will be required to dry material 1. Accordingly, controller 200 can provide an increased temperature set point to heater 140, thereby providing a desired exhaust hood temperature as measured at sensor TC01.

In a yet further embodiment of the invention, the angle of vibration supplied by vibratory drive 50 is set by controller 200 to permit the fluid bed dryer 20 deck 30 to remain filled with wet material 1, thereby providing for a hot gas stream constantly in contact with the maximum amount of material 1. Weir 60 is periodically opened to remove large particles of material 1 through outlet 44, which may be reintroduced into product inlet port 42. Gas stream velocity and temperature are controlled through operation of damper 130 and heater 140 such that most particles of a predetermined size are entrained in the air stream exiting through exhaust header 160, thence deposited in cyclone 170.

Thus the present invention 10 is capable of controlling the drying and transporting of wet materials by controlling multiple process variables: drying air stream temperature as measured at a plurality of locations, drying air stream velocity, pressure across distribution plate 30 and fluid bed dryer 20 distribution plate 30 angle of vibration.

In a yet further embodiment of the present invention, a cooling air stream may be provided to material 1 by not activating heater 140, or alternatively by providing an air cooler (not shown) in its place. In this embodiment of the invention, material 1 may enter inlet port 42 in a heated state whereby fluid bed dryer provides cool air through inlet air header 150 to cool material 1 while the fluidizing and vibratory action of the system 10 reduces material 1 particle size until the finished particles are of sufficient size and moisture content to be entrained in the exhaust air stream.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

I claim:

1. A system for drying and conveying a moisture-laden material comprising:
a fluid bed dryer comprising:
a housing having a material inlet at a first end thereof, an overs outlet at a second end thereof, and a finished material outlet;
a conveying deck on which said material is conveyed having a porous conveying surface through which said hot air is directed; and
an inlet air header having a plurality of inlet air ports in fluid communication with said housing, said inlet air head supplying drying fluid to a bottom surface of said conveying deck; and
a flash dryer in fluid communication with said finished product outlet having an exhaust for pulling dried material from said finished product outlet, and a cyclone storage hopper into which dried material is deposited.

2. A system for drying and conveying a moisture-laden material as claimed in claim 1 comprising:
a conveying deck having a corrugated cross-section for maximizing drying airflow therethrough.

3. A system for drying and conveying a moisture-laden material as claimed in claim 1 comprising:
a vibratory conveying deck mounted on a plurality of spring members, said conveying deck having a vibratory drive secured thereto for imparting vibratory motion to said conveying deck, whereby said material particle size is reduced by said vibratory motion.

4. A system for drying and conveying a moisture-laden material as claimed in claim 1 comprising:
an exhaust header disposed between said finished material outlet and said cyclone for providing a means of egress for material particles of a predetermined size.

5. A system for drying and conveying a moisture-laden material as claimed in claim 1 comprising:
an inlet air header having a plurality of inlet air ports proximate a bottom surface of said conveyor deck for entraining air particles of a predetermined size into an exhaust air stream.

6. A system for drying and conveying a moisture-laden material as claimed in claim 1 comprising:
an air heater for supplying drying air to said inlet air header.

7. A system for drying and conveying a moisture-laden material as claimed in claim 6 comprising:
a first temperature sensor for measuring inlet air temperature, said air heater responsive to said first temperature sensor.

8. A system for drying and conveying a moisture-laden material as claimed in claim 7 comprising:
a second temperature sensor for measuring outlet air temperature, said air heater responsive to said second temperature sensor.

9. A system for drying and conveying a moisture-laden material as claimed in claim 8 wherein said air heater is responsive to a predetermined temperature differential between the temperatures measured by said first and second temperature sensors.

10. A system for drying and conveying a moisture-laden material as claimed in claim 1 comprising:
a housing having a plurality of finished material outlets proximate the upper surface of said conveying deck, for removal of material entrained in an exhaust air stream.

11. A system for drying and conveying a moisture-laden material as claimed in claim 10 comprising:
an exhaust header having a plurality of exhaust ports in fluid communication with said plurality of finished material outlets for removing dried material to said cyclone.

12. A system for drying and conveying a moisture-laden material as claimed in claim 11 comprising:
an exhaust air system for supplying a negative air pressure to said exhaust header and said cyclone, whereby said material entrained in an exhaust air stream exits said housing and is deposited in said cyclone.

13. A system for drying and conveying a moisture-laden material and reducing the particle size thereof comprising:
a vibratory fluid bed dryer having a porous conveying distribution plate onto which said material is deposited, and a housing surrounding said plate;
a vibratory drive for imparting vibratory force of a variable angle and magnitude to said distribution plate;
a flash dryer for supplying a drying fluid to said fluid bed dryer, whereby said fluid passes through said distribution plate; and
a controller operatively coupled to said vibratory drive for varying the angle and magnitude of the force imparted thereto, said controller having a plurality of inputs and outputs.

14. A system for drying and conveying a moisture-laden material as claimed in claim 13 comprising:
a flash dryer having an inlet air fan for supplying inlet air and an inlet air heater for heating said inlet air, said fan in fluid communication with said fluid bed dryer.

15. A system for drying and conveying a moisture-laden material as claimed in claim 14 comprising:
a flash dryer having an exhaust fan in fluid communication with said fluid bed dryer housing, for removing dry material therefrom; and
a cyclone in fluid communication with said exhaust fan for storing dry material.

16. A system for drying and conveying a moisture-laden material as claimed in claim 1 comprising:
a temperature sensor positioned within said vibratory fluid bed dryer above said distribution deck operatively having an output representative of exhaust air temperature operatively coupled to said controller;
an temperature setpoint output from said controller operatively coupled to said inlet air heater for providing an inlet air temperature setpoint to said heater.

17. A system for drying and conveying a moisture-laden material as claimed in claim 16 whereby said controller maintains a predetermined temperature of said exhaust air stream as measured by said temperature sensor by varying the temperature setpoint output to said inlet air heater.

18. A system for drying and conveying a moisture-laden material as claimed in claim 15 comprising:
a pressure transducer disposed in said vibratory flash dryer above said distribution plate for monitoring the air pressure above said plate.

19. A system for drying and conveying a moisture-laden material as claimed in claim 18 comprising:
an inlet air damper in fluid communication with said inlet air fan for controlling the inlet air volume supplied to said vibratory fluid bed dryer, said damper having an input operatively coupled to said controller for accepting a controller output representative of inlet air damper position; and
an exhaust air damper in fluid communication with said inlet air fan for controlling the exhaust air volume exiting said vibratory fluid bed dryer, said damper having an input operatively coupled to said controller for accepting a controller output representative of exhaust damper position.

20. A system for drying and conveying a moisture-laden material as claimed in claim 19 wherein said inlet air damper and said exhaust air damper are positioned to provide a negative pressure above said distribution plate, whereby said dry material is entrained in said exhaust air stream.
